(19) United States
(12) Patent Application Publication
(10) Pub. No.: US 2006/0061511 A1
(43) Pub. Date: Mar. 23, 2006

(54) Active antenna

(75) Inventors: Takashi Enoki, Yokohama-shi (JP); Tomohiro Seki, Musashino-shi (JP); Takeo Atsugi, Musashino-shi (JP); Masahiro Umehira, Musashino-shi (JP)

Correspondence Address: STEVENS, DAVIS, MILLER & MOSHER, LLP, 1615 L. STREET N.W., SUITE 850, WASHINGTON, DC, 20036, US

(73) Assignees: PANASONIC MOBILE COMMUNICATIONS CO.,LTD., Kanagawa (JP); NIPPON TELEGRAPH AND TELEPHONE CORPORATION, Tokyo (JP)

(21) Appl. No.: 10/534,530

(22) PCT Filed: Nov. 17, 2003
(86) PCT No.: PCT/JP03/14562

§ 371 Date: May 12, 2005

(30) Foreign Application Priority Data
Nov. 15, 2002 (JP) 2002-332509

(51) Int. Cl. H01Q 1/24

(52) U.S. Cl. 343/702

(57) ABSTRACT

An MSA feeder circuit (113) that feeds power to an MSA (112) and MSA (112) is disposed on an antenna substrate (106) and a high-output amplifier (102) and low-noise amplifier (103), etc., which are active devices, are mounted on an RF substrate (107). A heat radiation block (111) is interposed between the antenna substrate (106) and the RF substrate (107). An RF-antenna connection section (105) connects an MSA feeder circuit (113) disposed on the antenna substrate (106) and a feed line (109) on the RF substrate (107) through an electromagnetic field using a non-radiation connection slot (108). In this way, even when a device with high output and large power consumption is used, it is possible to provide an active antenna which can suppress deterioration of the characteristic and which can be implemented in a simple configuration and can be downsized.

### TECHNICAL FIELD

The present invention relates to an active antenna having a structure with active devices such as high-output amplifier, low-noise amplifier integrated with antenna elements.

### BACKGROUND ART

At frequencies not lower than frequencies of a quasi-millimeter waveband, electromagnetic waves undergo large propagation attenuation in space and it is therefore necessary to improve output power and increase antenna gains in order to secure a sufficient communication area.

Since a conventional radio set connects an independent antenna with the body of the radio set using a coaxial cable, etc., it is necessary to increase the output power and gain of the final stage amplifier to compensate for a cable loss. One of measures for meeting this need is an active antenna which integrates an antenna and an RF circuit (mounted with active devices).

A mounting cross-sectional view of a conventional active antenna is shown in FIG. 1. An RF circuit of the active antenna is disposed on an RF-antenna integrated multilayer substrate 11 or inner layer. When the antenna is assumed to be a micro strip antenna (MSA) 12, a GND (ground) layer 13 is required from the standpoint of the structure of the antenna and an MMIC (Microwave Monolithic Integrated Circuit) 14 such as a power amplifier, low-noise amplifier or transmission/reception changeover switch is normally mounted on the side opposite to the antenna. The transmission/reception changeover switch and antenna are connected together through an RF-antenna connection through hole 15.

However, a system using a quasi-millimeter waveband or higher band needs to adopt a structure for reducing a loss between the antenna and RF circuit as shown in FIG. 1 and needs to use a high-output power amplifier to expand a communication area and secure transmission quality. When the MMIC is mounted on the substrate as described above, there is a limit to an amount of heat radiation therefrom and when the device operates under a high-temperature condition, it is also necessary to consider deterioration, etc., of the characteristic thereof and the MMIC may be destroyed when used for a long time in the worst case.

### DISCLOSURE OF INVENTION

It is an object of the present invention to provide an active antenna having a simple structure which can suppress, even when a device with high output and large power consumption is used, deterioration of the characteristic thereof and which can be downsized.

This object can be attained by an active antenna comprising an antenna, a high-output amplifier that amplifies a signal and outputs the signal to the antenna, a low-noise amplifier that amplifies the signal received by the antenna, an antenna substrate including the antenna and a feeder circuit that feeds power to the antenna, an RF substrate that is mounted with the high-output amplifier and the low-noise amplifier which are active devices and a heat radiation block inserted between the antenna substrate and the RF substrate, wherein the antenna substrate and the RF substrate are connected through an electromagnetic field by a connection slot.

### BRIEF DESCRIPTION OF DRAWINGS

FIG. 1 is a mounting cross-sectional view of a conventional active antenna;

FIG. 2 is a block diagram showing the configuration of an active antenna according to Embodiment 1 of the present invention;

FIG. 3 is a mounting cross-sectional view of the active antenna according to Embodiment 1 of the present invention;

FIG. 4A is a detail view (top view) of the RF-antenna connection section according to Embodiment 1 of the present invention;

FIG. 4B is a detail view (cross-sectional view) of the RF-antenna connection section according to Embodiment 1 of the present invention;

FIG. 5 is a block diagram showing the configuration of an active antenna according to Embodiment 2 of the present invention;

FIG. 6 is a block diagram showing the configuration of an active antenna according to Embodiment 3 of the present invention;

FIG. 7 is a block diagram showing the configuration of an active antenna according to Embodiment 4 of the present invention; and

FIG. 8 is a block diagram showing the configuration of an active antenna according to Embodiment 5 of the present invention.

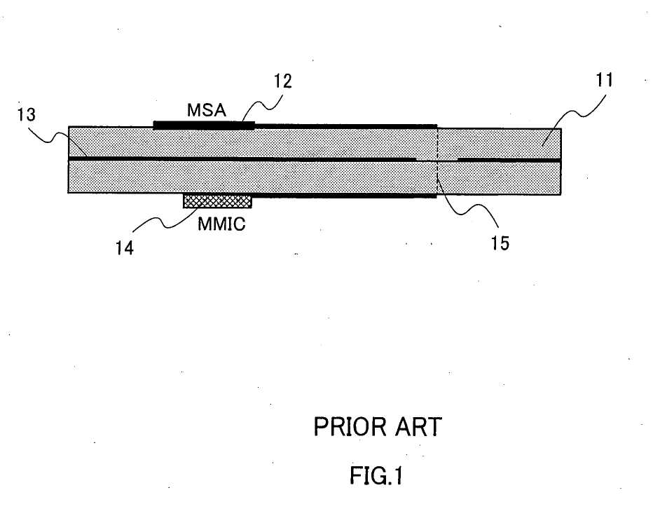

### BEST MODE FOR CARRYING OUT THE INVENTION

With reference now to the attached drawings, embodiments of the present invention will be explained in detail below.

### Embodiment 1

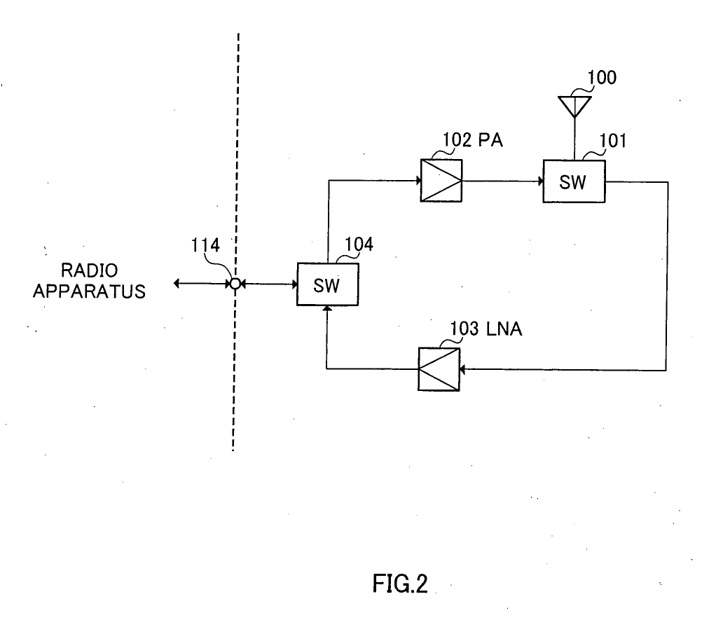

FIG. 2 is a block diagram showing the circuit configuration of an active antenna according to Embodiment 1 of the present invention.

The circuit of the active antenna shown in FIG. 2 is provided with an antenna 100, a high-output amplifier (PA) 102, a low-noise amplifier (LNA) 103, a transmission/reception changeover switch 101 that separates an antenna signal line into a transmitting side and a receiving side and a transmission/reception changeover switch 104 that separates a signal line connected to a radio apparatus into a transmitting side and receiving side.

The signal path is as follows. A transmission signal input from a radio apparatus through a radio apparatus connection end 114 is output to the high-output amplifier 102 with the output destination switched by the transmission/reception changeover switch 104. The transmission signal whose power is amplified by the high-output amplifier 102 radiates out into space through the antenna 100 with the output destination switched by transmission/reception changeover switch 101. On the other hand, a signal received through the antenna 100 is output to the low-noise amplifier 103 with the output destination switched by the transmission/reception changeover switch 101. The received signal amplified by the low-noise amplifier 103 is output to the radio apparatus through the radio apparatus connection end 114 with the output destination switched by the transmission/reception changeover switch 104.

Here, the configurations of the transmission/reception changeover switch 101 and transmission/reception changeover switch 104 vary depending on the system applied and, for example, in the case of a TDD (Time Division Duplex) system in which the same frequency is used for transmission and reception, both switches adopt a switch configuration selecting the transmitting side or receiving side at certain time periods, while in the case of an FDD (Frequency Division Duplex) system, both switches may adopt a duplexer combining filters or a combination of a switch and a filter and the switches are not limited to any particular configuration.

Furthermore, depending on a required noise factor (NF) of the entire system, the low-noise amplifier 103 need not necessarily be mounted on the active antenna side and may also be mounted on the radio apparatus side connected to the radio apparatus connection end 114.

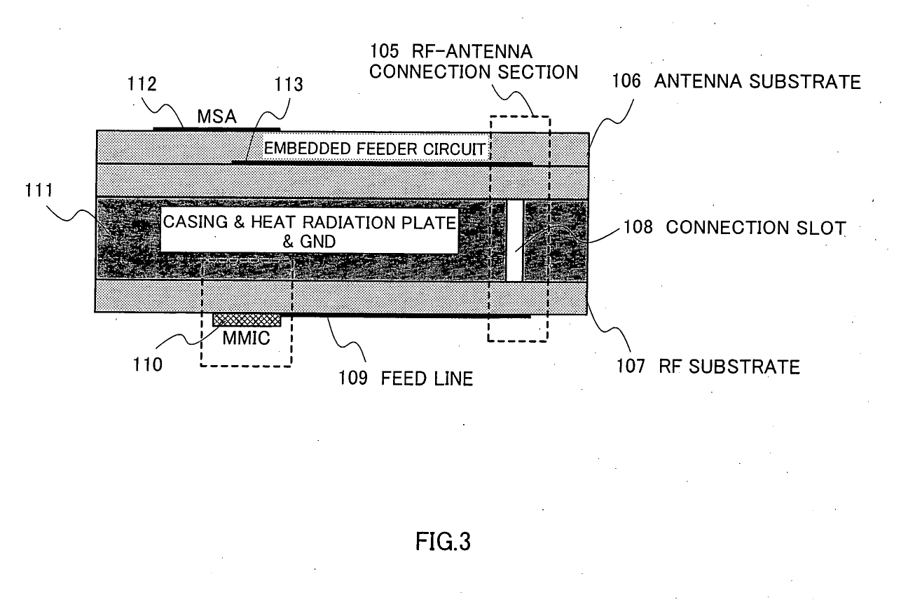

Next, a mounting cross-sectional view of the active antenna according to this embodiment is shown in FIG. 3. Here, a micro strip antenna (MSA) 112 will be shown as an example of the antenna. Furthermore, for simplicity of explanation, only one patch is shown but it is also possible to use a plurality of patch antennas.

As shown in FIG. 3, the active antenna according to this embodiment is mainly constructed of an antenna substrate 106, a heat radiation block 111 and an RF substrate 107. The heat radiation block 111 also serves as a casing and GND (ground).

The MSA 112 is disposed on the antenna substrate 106 and an MSA feeder circuit (embedded feeder circuit) 113 that feeds power to the MSA 112 is disposed inside the antenna substrate 106. Furthermore, an MMIC 110 that is mounted with the high-output amplifier 102 and the low-noise amplifier 103, etc., which are active devices, is disposed on an RF substrate 107.

Then, a heat radiation block 111 is interposed (inserted) between the antenna substrate 106 and RF substrate 107, the antenna substrate 106 is in close contact with the heat radiation block 111 and the heat radiation block 111 is in close contact with the RF substrate 107. Adopting such a configuration of the substrates disposed in close contact with each other secures the unity as the active antenna. Furthermore, the close contact between the heat radiation block 111 and RF substrate 107 allows heat generated in the RF substrate 107 to radiate out efficiently.

Furthermore, this heat radiation block 111 is provided with a hollow connection slot 108. The antenna substrate 106 and RF substrate 107 are connected together via an RF-antenna connection section 105 including this connection slot 108.

Here, the connection slot 108 has a configuration similar to that of a normal slot antenna and is a non-radiation slot that produces no unnecessary radiation outward. The connection slot 108 connects the MSA feeder circuit 113 and a feed line 109 on the front and back through an electromagnetic field (that is, an electromagnetic wave which radiates out from the feed line 109 passes through the air, etc., in the slot and reaches the MSA feeder circuit 113 during transmission, while an electromagnetic wave received by the MSA 112 passes through the MSA feeder circuit 113, radiates out into the slot and reaches the feed line 109 during reception).

In order to reduce mutual connection between the connection slot and antenna, the RF-antenna connection section 105 including the connection slot 108 is disposed on the antenna substrate 106 at a predetermined distance from the MSA 112.

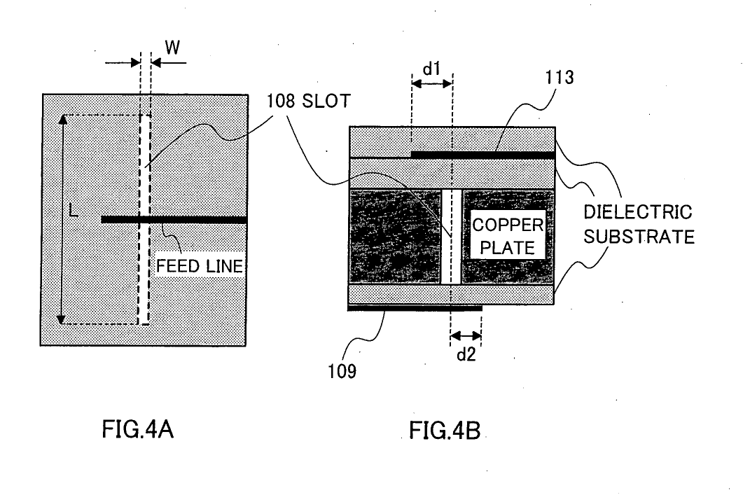

FIG. 4 shows a further detailed structure of the RF-antenna connection section 105. However, a case where the MSA feeder circuit 113 is disposed at a position different from that in FIG. 3 is shown here. In FIG. 3, the case where the MSA feeder circuit 113 as with the feed line 109 is disposed to the left of the connection slot 108 has been explained as an example, but as shown in FIG. 4, the MSA feeder circuit 113 may also be disposed to the right (in FIG. 3) of the connection slot 108.

FIG. 4A is a top view (upside in FIG. 3) of the RF-antenna connection section 105. As shown in the figure, the heat radiation block 111 is hollowed out in a rectangular shape to form the connection slot 108. Here, the connection slot 108 and the feed lines of MSA feeder circuit 113 are disposed so as to cross each other at right angles to improve radiant efficiency (impedance characteristic) of electromagnetic waves. Though not shown, the connection slot 108 and feed line 109 are also disposed so as to cross each other at right angles.

Furthermore, the value of W is preferably small considering the impedance characteristic of the connection slot 108. On the other hand, the value of L is also preferably small to form a non-radiation slot, but the value of L is determined according to the frequency to be used considering also the thickness t of the heat radiation block 111. That is, the thickness t of the heat radiation block 111 is preferably large considering the radiation characteristic, whereas it is a known fact there is a proportional relationship between L and t, and when L is increased according to t, it is difficult to make the connection slot 108 a non-radiation slot. Thus, there is a tradeoff relationship between realization of non-radiation and improvement of a radiation characteristic and L is determined considering the frequency used.

Here, the case where the top view of the connection slot 108 has a rectangular shape has been explained as an example, but the shape of the connection slot 108 is not limited to this and any other shape is also acceptable if W and L at least satisfy the above described conditions.

FIG. 4B is a cross-sectional view of the RF-antenna connection section 105 viewed from the same direction as that in FIG. 3. Here, d1 and d2 are determined to be values optimizing the impedance characteristic of the connection slot 108.

For an active device such as the high-output amplifier 102, a maximum allowable temperature of the element itself is specified and it is necessary to design heat radiation so that the element temperature does not exceed that temperature. When sufficient heat radiation cannot be provided, no element handling such high power can be mounted. Furthermore, an active element is characterized in that the gain thereof decreases in a high temperature range and it is possible to suppress deterioration of the characteristic by adopting a design which prevents the element temperature from increasing.

Thus, this embodiment transmits heat generated by the high-output amplifier mounted on the RF substrate 107 through the RF substrate 107 to the heat radiation block 111 having high thermal conductivity (e.g., made of copper) provided in close contact with the RF substrate 107 and discharges heat into the air through this heat radiation block.

Furthermore, in this embodiment, the RF substrate 107 (feed line 109) and antenna substrate 106 (MSA feeder circuit 113) are electrically disconnected because of the presence of the heat radiation block 111, but by providing the connection slot 108 by hollowing out part of the heat radiation block 111, the power from the feed line 109 is passed through this connection slot 108 and supplied to the MSA feeder circuit 113. That is, the MSA feeder circuit 113 and feed line 109 are connected together through an electromagnetic field. Furthermore, by connecting the two substrates without soldering, etc., using connection means such as a coaxial cable, it is possible to easily manufacture the substrates in steps similar to those used in manufacturing a normal multilayer substrate.

Thus, according to this embodiment, even when a high-output, large power consumption device is used, it is possible to achieve sufficient heat radiation effects and suppress deterioration of the characteristic due to a temperature rise of the device. Furthermore, it is possible to provide an active antenna having a simple structure which can be downsized.

### Embodiment 2

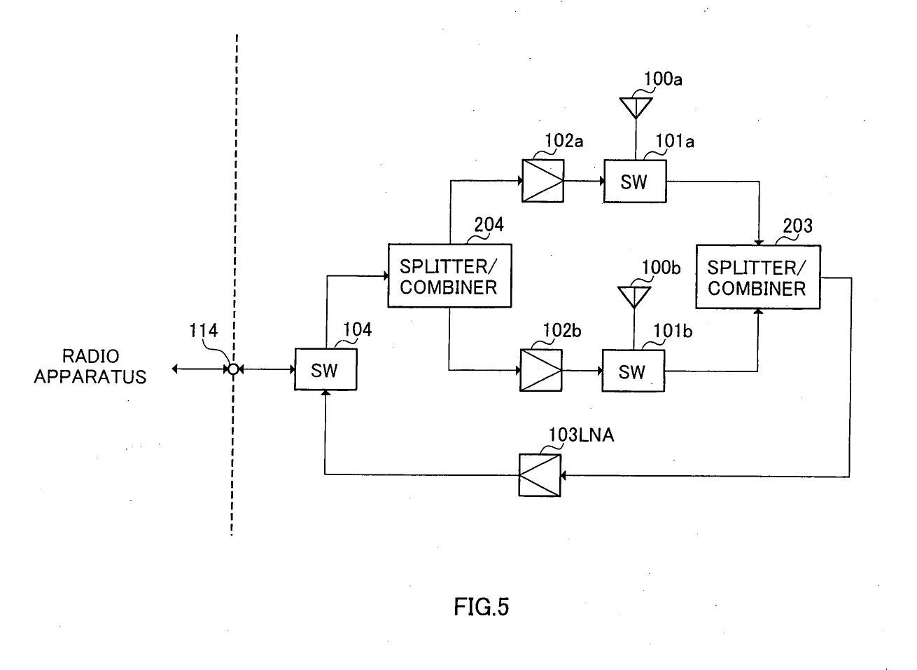

FIG. 5 is a block diagram showing the configuration of an active antenna according to Embodiment 2 of the present invention. This active antenna has a basic configuration similar to that of the active antenna shown in FIG. 2 and the same components are assigned the same reference numerals and explanations thereof will be omitted.

This embodiment is characterized in that two sets of the antenna 100 (antenna 100a, antenna 100b) shown in FIG. 2 are provided to realize a spatial combination of signals.

In FIG. 5, a transmission signal input from a radio apparatus through a radio apparatus connection end 114 is output to a splitter/combiner 204 with the output destination switched by a transmission/reception changeover switch 104 and split into two signals. The outputs of the splitter/combiner 204 are input to high-output amplifiers 102a, 102b. The transmission signals amplified by the high-output amplifiers 102a, 102b radiate out into space through antennas 100a, 100b with the respective output destinations switched by transmission/reception changeover switches 101a, 101b. On the other hand, signals received through the antennas 100a, 100b are input to a splitter/combiner 203 with their respective output destinations switched by the transmission/reception changeover switches 101a, 101b, combined and output to a low-noise amplifier 103. The received signal amplified by the low-noise amplifier 103 is output to the radio apparatus through the radio apparatus connection end 114 with the output destination switched by the transmission/reception changeover switch 104.

For example, when radio signals transmitted through two antennas are spatially combined, only half the output power of the amplifier is required in theory. Furthermore, even when the same output power in total is used, using a plurality of amplifiers having small maximum power generally results in small total power consumption. This embodiment is intended to achieve this effect.

Thus, this embodiment arranges a plurality of antennas and also a plurality of high-output amplifiers connected thereto, and therefore it is possible to decrease power consumption of one high-output amplifier and reduce overall power consumption compared to the case where one high-output amplifier is used by selecting the characteristic of the high-output amplifier.

Here, the case where two antenna sections and two signals are combined has been explained as an example, but it is also possible to combine more signals with a similar configuration.

### Embodiment 3

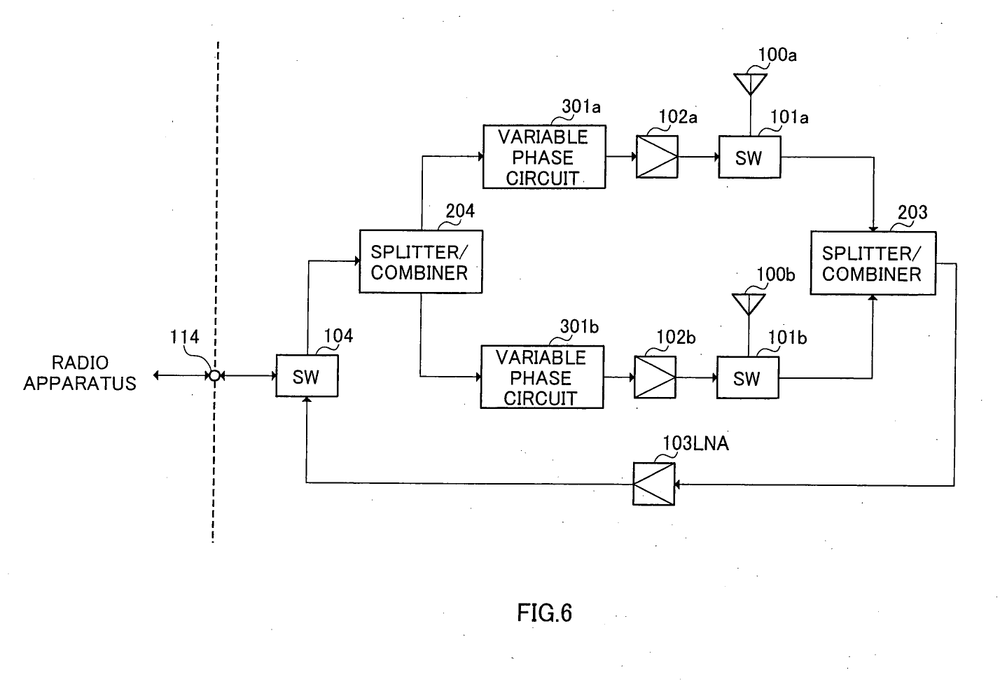

FIG. 6 is a block diagram showing the configuration of an active antenna according to Embodiment 3 of the present invention. This active antenna has a basic configuration similar to that of the active antenna shown in FIG. 5 and the same components are assigned the same reference numerals and explanations thereof will be omitted.

This embodiment is characterized in that variable phase circuits 301a, 301b are inserted between a splitter/combiner 204 and high-output amplifiers 102a, 102b.

In a circuit performing a spatial combination, signals must be emitted with the same phase from a plurality of antennas, but the phases may be actually shifted due to variations in each device, etc., and the variable phase circuits 301a, 301b have the functions of correcting those shifts.

Thus, this embodiment corrects variations of each device itself and phase variations during mounting, etc., and can thereby suppress combination losses and realize a high-gain active antenna.

### Embodiment 4

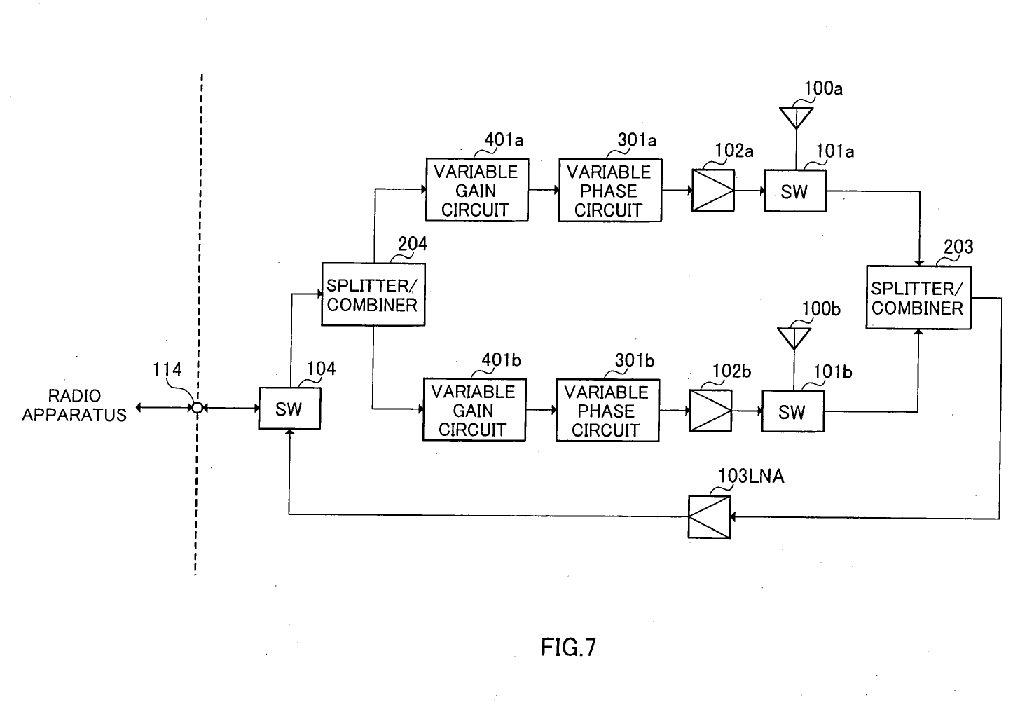

FIG. 7 is a block diagram showing the configuration of an active antenna according to Embodiment 4 of the present invention. This active antenna has a basic configuration similar to that of the active antenna shown in FIG. 6 and the same components are assigned the same reference numerals and explanations thereof will be omitted.

This embodiment is characterized in that variable gain circuits 401a, 401b are inserted between a splitter/combiner 204 and variable phase circuits 301a, 301b.

In a circuit performing a spatial combination, signals must be emitted with the same amplitude from a plurality of antennas, but amplitudes may be actually shifted due to variations in each device, etc., and the variable gain circuits 401a, 401b have the function of correcting those shifts.

Thus, this embodiment corrects variations of each device itself and amplitude variations during mounting, etc., and can thereby suppress combination losses and realize a high-gain active antenna. Furthermore, since there is no need to purchase a device by specifying the rank of the device, it is possible to realize cost reduction.

### Embodiment 5

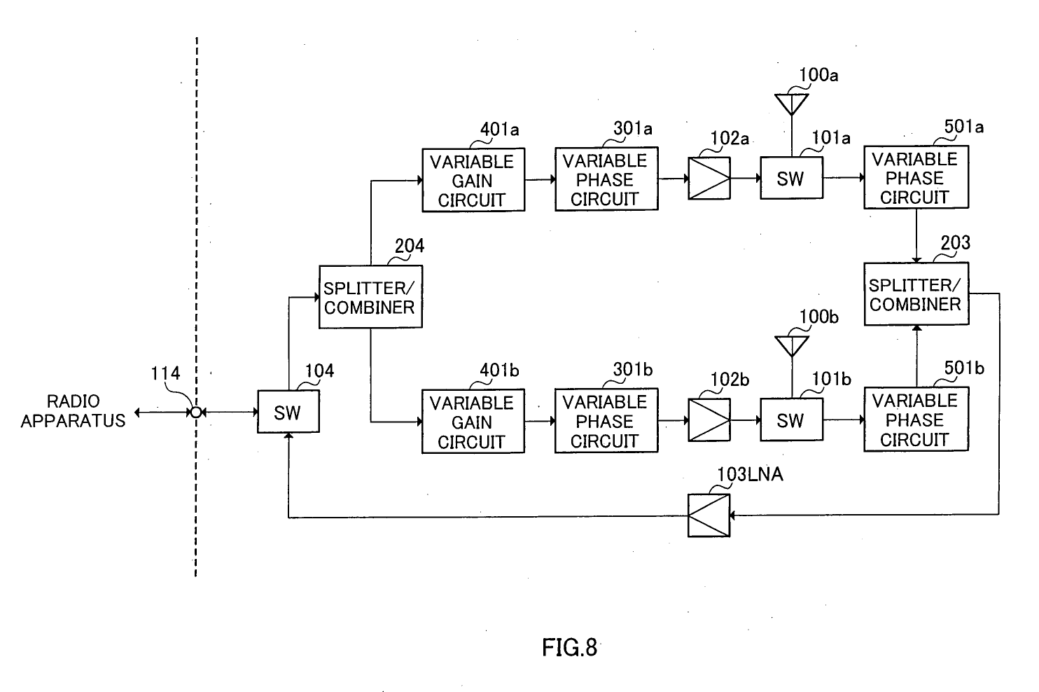

FIG. 8 is a block diagram showing the configuration of an active antenna according to Embodiment 5 of the present invention. This active antenna has a basic configuration similar to that of the active antenna shown in FIG. 7 and the same components are assigned the same reference numerals and explanations thereof will be omitted.

This embodiment is characterized in that variable phase circuits 501a, 501b are inserted between a splitter/combiner 203 and transmission/reception changeover switches 101a, 101b.

In a circuit performing a spatial combination, signals must be emitted with the same phase from a plurality of antennas, and the same applies to a received signal, but phases may be actually shifted due to variations in each device, etc., and the variable phase circuits 501a, 501b have the function of correcting those shifts.

Thus, this embodiment corrects variations of each device itself and phase variations during mounting, etc., and can thereby suppress combination losses and realize a high-gain active antenna also for a received signal.

As described so far, even when a device with high output and large power consumption is used, the present invention can realize an active antenna which can suppress deterioration of the characteristic thereof and which can be simply downsized.

This application is based on the Japanese Patent Application No. 2002-332509 filed on Nov. 15, 2002, entire content of which is expressly incorporated by reference herein.

### INDUSTRIAL APPLICABILITY

The present invention is applicable to an antenna mounted on a radio set, etc.

[FIG. 2]

Radio Apparatus

[FIG. 3]

105 RF-ANTENNA CONNECTION SECTION
106 ANTENNA SUBSTRATE
113 EMBEDDED FEEDER CIRCUIT
111 CASING & HEAT RADIATION PLATE & GND
108 CONNECTION SLOT
109 FEED LINE
107 RF SUBSTRATE
   [FIG. 5]
   Radio Apparatus
204 SPLITTER/COMBINER
203 SPLITTER/COMBINER
   [FIG. 6]
   Radio Apparatus
204 SPLITTER/COMBINER
301a VARIABLE PHASE CIRCUIT
301b VARIABLE PHASE CIRCUIT
203 SPLITTER/COMBINER
   [FIG. 7]
   Radio Apparatus
204 SPLITTER/COMBINER
401a VARIABLE GAIN CIRCUIT
401b VARIABLE GAIN CIRCUIT
301a VARIABLE PHASE CIRCUIT
301b VARIABLE PHASE CIRCUIT
203 SPLITTER/COMBINER
   [FIG. 8]
   Radio Apparatus
204 SPLITTER/COMBINER
401a VARIABLE GAIN CIRCUIT
401b VARIABLE GAIN CIRCUIT
301a VARIABLE PHASE CIRCUIT
301b VARIABLE PHASE CIRCUIT
501a VARIABLE PHASE CIRCUIT
203 SPLITTER/COMBINER
501b VARIABLE PHASE CIRCUIT

1. (canceled)

2. (canceled)

3. (canceled)

4. (canceled)

5. (canceled)

6. An active antenna having a multilayer structure comprising:
an antenna substrate on which an antenna is disposed;
a circuit substrate on which an amplification circuit for a signal transmitted/received through said antenna; and a heat radiation plate interposed between said antenna substrate and said circuit substrate,
wherein said heat radiation plate includes a communication hole that communicates said antenna substrate side with said circuit substrate side.

7. The active antenna according to claim 1, wherein said antenna is disposed apart from said communication hole on said antenna substrate and is supplied power from said communication hole through a feed line.

8. The active antenna according to claim 2, wherein said communication hole is slot-shaped, and
said feed line is disposed in a direction perpendicular to the longitudinal direction of the slot shape of said communication hole on said antenna substrate.

9. The active antenna according to claim 3, wherein said length in the longitudinal direction of said communication hole is determined based on both the thickness of said heat radiation plate and the frequency used of said antenna.

10. An active antenna comprising:
an antenna;
a high-output amplifier that amplifies a signal and outputs the signal to said antenna;
a low-noise amplifier that amplifies the signal received by said antenna;
an antenna substrate that includes said antenna and a feeder circuit that feeds power to said antenna;
an RF substrate that is mounted with said high-output amplifier and said low-noise amplifier which are active devices; and
a heat radiation block inserted between said antenna substrate and said RF substrate,
wherein said antenna substrate and said RF substrate are connected through an electromagnetic field by a connection slot.

11. The active antenna according to claim 5, further comprising:
a plurality of said antennas;
the same number of said high-output amplifiers as said antennas;
a splitter that splits a signal into as many signals as said antennas and outputs the signals to said high-output amplifier; and
a combiner that combines the signals received by said antennas and outputs the combined signal to said low-noise amplifier,
wherein signals are spatially combined.

12. The active antenna according to claim 6, wherein a variable phase circuit is interposed between said high-output amplifier and said splitter or between said high-output amplifier and said antenna.

13. The active antenna according to claim 6, wherein a variable gain circuit is interposed between said high-output amplifier and said splitter or between said high-output amplifier and said antenna.

14. The active antenna according to claim 6, wherein a variable phase circuit is interposed between said combiner and said antenna.

15. An active antenna manufacturing method comprising:
a step of providing a slot-shaped through hole in a heat radiation plate; and
a step of forming a multilayer structure comprising an antenna substrate on which an antenna is disposed, a circuit substrate on which an amplification circuit for a signal transmitted/received through said antenna and a heat radiation plate provided with a through hole interposed between said antenna substrate and said circuit substrate.
